(19) United States
(12) Patent Application Publication
(10) Pub. No.: US 2005/0156057 A1
(43) Pub. Date: Jul. 21, 2005

(54) Pump-nozzle unit and method for setting the hardness of bearing regions of a control valve

(75) Inventors: Christoph Hamann, Thalmassing (DE); Maximilian Kronberger, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Volkswagen Mechatronic GmbH & Co. KG

(21) Appl. No.: 11/078,674

(22) Filed: Mar. 11, 2005

Related U.S. Application Data
(63) Continuation of application No. PCT/DE03/03027, filed on Sep. 12, 2003.

(30) Foreign Application Priority Data
Sep. 12, 2002 (DE) 102 42 376.8

(51) Int. Cl. B05B 1/08

(52) U.S. Cl. 239/102.2

(57) ABSTRACT

A pump-nozzle unit for feeding fuel into a combustion chamber of an internal combustion engine, having a controllable fuel pump, which comprises a control valve with a valve needle which is deflected by a piezo actuator, the comparatively small travel of the piezo actuator being increased by a mechanical step-up converter to the extent required for deflection of the valve needle. In order not to endanger the ability of the control valve housing to withstand pressure yet nevertheless to provide relatively wear-resistant bearing regions (80, 82) which come into contact with the mechanical step-up converter (56, 58), it is provided that the control valve housing is formed from a material with a relatively low basic hardness, for example from Ovako 677, and that the bearing regions (80, 82) of the control valve (22) are hardened further by laser means.

### CROSS REFERENCE TO RELATED APPLICATION

This application is a continuation of copending International Application No. PCT/DE03/03027 filed Sep. 12, 2003 which designates the United States, and claims priority to German application no. 102 42 376.8 filed Sep. 12, 2002.

### TECHNICAL FIELD OF THE INVENTION

The present invention relates to a pump-nozzle unit for feeding fuel into a combustion chamber of an internal combustion engine, having a controllable fuel pump, which comprises a control valve with a valve needle which is deflected by a piezo actuator, the comparatively small travel of the piezo actuator being increased by a mechanical step-up converter to the extent required for deflection of the valve needle. Furthermore, the invention relates to a method for setting the hardness of at least some bearing regions of a control valve, which come into contact with a mechanical step-up converter, for a pump-nozzle unit for feeding fuel into a combustion chamber of an internal combustion engine, the mechanical step-up converter being provided for the purpose of increasing a relatively small travel caused by a piezo actuator to an extent required for deflection of a valve needle of the control valve.

Pump-nozzle units are used to feed fuel into a combustion chamber of an internal combustion engine. This may, for example, be a pump-nozzle unit having a controllable fuel pump, a fuel injection nozzle, which includes a nozzle needle that can move to and from between a closed position and an open position, a first pressure space, which can be filled with fuel under a first pressure by the fuel pump, a second pressure space, with fuel which is under a second pressure in the second pressure space exerting a closure force on the nozzle needle, and a third pressure space, which is in communication with the first pressure space, fuel that is under a third pressure in the third pressure space exerting an opening force on the nozzle needle.

### DESCRIPTION OF THE RELATED ART

Pump-nozzle units are used in particular in combination with pressure-controlled injection systems. One main feature of a pressure-controlled injection system is that the fuel injection nozzle opens as soon as an opening force which is at least influenced by the currently prevailing pressures is exerted on the nozzle needle. Pressure-controlled injection systems of this type are used for fuel metering, fuel preparation, to shape the injection profile and to seal off the supply of fuel with respect to the combustion chamber of the internal combustion engine. The time curve of the quantitative flow during injection can be controlled in an advantageous way by means of pressure-controlled injection systems. This can have a positive influence on the power, fuel consumption and pollutant emission of the engine.

In the case of pump-nozzle units, the fuel pump and the fuel injection nozzle are generally designed as an integrated component. For each combustion chamber of the internal combustion engine, at least one pump-nozzle unit is provided, which is generally installed in the cylinder head. The fuel pump typically comprises a fuel pump piston which can move to and fro in a fuel pump cylinder and is driven by a camshaft of the internal combustion engine, either directly via a tappet or indirectly via rocker levers. The portion of the fuel pump cylinder which usually forms the first pressure space can be connected via a control valve to a low-pressure fuel region, with fuel, when the control valve is open, being sucked into the first pressure space from the low-pressure fuel region and then being forced back into the low-pressure fuel region from the first pressure space when the control valve remains open. As soon as the control valve is closed, the fuel pump piston compresses the fuel in the first pressure space and thereby builds up the pressure. It is known to provide the control valve in the form of a solenoid valve. However, solenoid valves usually have a relatively long response time, which is caused in particular by the fact that the magnet armature of a solenoid valve cannot be accelerated as quickly as desired, on account of the mass inertial forces, which are dependent on its mass. Furthermore, building up the magnetic field to generate the attraction force also takes time. A pump-nozzle unit equipped with a solenoid valve is known, for example, from EP 0 277 939 B1.

Piezo actuators of a suitable size can only generate a relatively small travel. Therefore, it has already been proposed to provide a mechanical step-up converter, which increases the relatively small travel produced by the piezo actuator to an extent required for deflection of the valve needle of the control valve. The mechanical step-up converter may, for example, be formed by one or more levers. The bearing regions of the control valve which come into contact with the mechanical step-up converter are exposed to very high pressures and are therefore subject to high levels of wear, even though the control valve body which forms the bearing regions is generally fully hardened, for example with the aid of an air-hardening process. A further problem is that hardening processes which lead to a higher hardness also increase the brittleness of the material. In the case of control valves in which high pressures are present, this has an adverse effect on the ability to withstand these pressures.

### SUMMARY OF THE INVENTION

The invention is based on the object of developing the pump-nozzle units of the generic type and the methods of the generic type in such a manner that the susceptibility of the bearing regions of the control valve which come into contact with the mechanical step-up converter to wear is reduced without any detrimental influence on the ability of the control valve to withstand pressure.

This object can be achieved by a pump-nozzle unit for feeding fuel into a combustion chamber of an internal combustion engine, comprising a controllable fuel pump, which comprises a control valve with a valve needle which is deflected by a piezo actuator, the comparatively small travel of the piezo actuator being increased by a mechanical step-up converter to the extent required for deflection of the valve needle, wherein bearing regions of the control valve which come into contact with the step-up converter at least in part have a higher hardness than regions which adjoin these bearing regions.

The hardness of the regions which adjoin the bearing regions with a higher hardness can be set by an air-hardening process. The hardness of the bearing regions with a higher hardness can be set by a laser-hardening process. The laser-hardening process can be applied to material that has already been hardened by an air-hardening process. The laser-hardening process can be carried out with the aid of a diode laser. The material which has already been hardened by an air-hardening process can be “Ovako 677”. The bearing regions with a higher hardness and the regions which adjoin these bearing regions can be formed integrally. The bearing regions with a higher hardness may have a hardness in the range from 760 HV to 850 HV. The regions which adjoin the bearing regions with a higher hardness may have a hardness in the range from 600 HV to 750 HV. The bearing regions with a higher hardness can be at least partially reground. The bearing regions with a higher hardness may have a depth of approximately 0.2 mm.

The object can also be achieved by a method for setting the hardness of at least some bearing regions of a control valve, which come into contact with a mechanical step-up converter, for a pump-nozzle unit for feeding fuel into a combustion chamber of an internal combustion engine, the method comprising the steps of providing the mechanical step-up converter for the purpose of increasing a relatively small travel caused by a piezo actuator to an extent required for deflection of a valve needle of the control valve, and hardening the bearing regions, which come into contact with the step-up converter, of the control valve at least partially in such a manner that their hardness is higher than the hardness of regions which adjoin these bearing regions.

The hardness of the regions which adjoin the bearing regions with a higher hardness can be set by an air-hardening process. The hardness of the bearing regions with a higher hardness can be set by a laser-hardening process. The laser-hardening process can be applied to material that has already been hardened by an air-hardening process. The laser-hardening process can be carried out with the aid of a diode laser. The material that has already been hardened by an air-hardening process can be “Ovako 677”. The bearing regions with a higher hardness and the regions which adjoin these bearing regions can be formed integrally. The bearing regions with a higher hardness may reach a hardness in the range from 760 HV to 850 HV. The regions which adjoin the bearing regions with a higher hardness may have a hardness in the range from 600 HV to 750 HV. The bearing regions with a higher hardness can be at least partially reground. The bearing regions with a higher hardness can be formed with a depth of approximately 0.2 mm. The hardness of the bearing regions with a higher hardness can be set by a diode laser-hardening process, the diode laser being operated as a function of an output signal from at least one photodiode which records emitted radiation. The emitted radiation can be thermal radiation. The hardness of the bearing regions with a higher hardness can be set by a diode laser-hardening process, the diode laser being operated as a function of an output signal from at least one photodiode which records reflected radiation. The reflected radiation can be laser radiation.

The pump-nozzle unit according to the invention builds on the generic prior art through the fact that bearing regions of the control valve which come into contact with the step-up converter at least in part have a higher hardness than regions which adjoin these bearing regions. This solution makes it possible to optimize the strength of the control valve both with regard to the ability to withstand pressure and with regard to the susceptibility of the bearing regions to wear.

In a preferred embodiment of the pump-nozzle unit according to the invention, it is provided that the hardness of the regions which adjoin the bearing regions with a higher hardness is set by an air-hardening process. Air-hardening processes are distinguished by the fact that the heated steel is cooled slowly in air in order to form a martensite with a high hardness. In this context, it is desirable to produce a martensite microstructure which is at least of equal quality to the martensite microstructure that can be produced by oil or salt bath hardening processes. For this purpose it is possible, for example, to use steel compositions which comprise silicon, manganese and molybdenum in combination with chromium and different carbon contents.

In an embodiment of the pump-nozzle unit according to the invention which is likewise preferred, it is provided that the hardness of the bearing regions with a higher hardness is set by a laser-hardening process.

In this context, it is deemed particularly advantageous if it is also provided that the laser-hardening process has been applied to material that has already been hardened by an air-hardening process. The air-hardening process can be used to harden the material to 680 HV, for example, using standard cooling conditions without having an excessively detrimental influence on the materials properties in terms of the ability to withstand pressures. Then, the hardness of the bearing regions can be increased to, for example, 800 HV by laser-beam processes. A laser with a rectangular beam can advantageously be used for hardening, in which case the bearing regions to be hardened can be briefly heated by the laser beam to the austenitizing temperature before then generating the high hardness by self-quenching, for example, after the laser beam has been switched off. On account of the short action time and the associated low level of energy, it is in many cases possible to ensure that the region in which the hardened body is tempered is small and therefore it is possible to avoid the formation of cracks which are otherwise produced during further hardening.

The advantages explained above can be achieved in particular if it is provided that the laser-hardening process has been carried out with the aid of a diode laser. Diode lasers, in particular high-power diode lasers, have a very good electrical efficiency (for example better by a factor of 10 than an Nd: YAG laser). They can be realized with an extremely compact overall structure (for example a size of a factor of 0.1 compared to a CO₂ laser).

Furthermore, it is preferable for the material which has already been hardened by an air-hardening process to be “Ovako 677”. The steel “Ovako 677” supplied by the company Ovako has better full-hardening properties during slow cooling under open air than, for example, a normal DIN 100 Cr 6 steel during rapid oil hardening.

A likewise preferred refinement of the pump-nozzle unit according to the invention provides for the bearing regions with a higher hardness and the regions which adjoin these bearing regions to be formed integrally.

In general, it is preferable for the bearing regions with a higher hardness to have a hardness in the range from 760 HV to 850 HV. A range which is particularly preferred in this context is from 760 HV to 780 HV.

Furthermore, it is generally preferable for the regions which adjoin the bearing regions with a higher hardness to have a hardness in the range from 600 HV to 750 HV. A particularly preferred range extends from 650 HV to 720 HV.

Further advantages can be achieved if it is provided, in the pump-nozzle unit according to the invention, that the bearing regions with a higher hardness be at least partially reground. Good results are achieved, for example, if approximately 50 μm of the material is removed.

Furthermore, it is considered advantageous if it is provided that the bearing regions with a higher hardness have a depth of approximately 0.2 mm.

The method according to the invention builds on the generic prior art through the fact that the bearing regions, which come into contact with the step-up converter, of the control valve are at least partially hardened further in such a manner that their hardness is higher than the hardness of regions which adjoin these bearing regions. This results in the advantages which have been explained in connection with the pump-nozzle unit according to the invention in the same or a similar way, and consequently to avoid repetition reference is made to the corresponding statements.

The same also applies accordingly to the following preferred embodiments of the method according to the invention, in which context, with regard to the advantages that can be achieved by these embodiments, reference is also made to the corresponding statements in connection with the pump-nozzle unit according to the invention.

In advantageous embodiments of the method according to the invention it is also provided that the hardness of the regions which adjoin the bearing regions with a higher hardness has been set by an air-hardening process.

Furthermore, it is deemed advantageous to use embodiments of the method according to the invention in which it is provided that the hardness of the bearing regions with a higher hardness is set by a laser-hardening process.

In the method according to the invention, it is in this context preferable for the laser-hardening method to be applied to material which has already been hardened by an air-hardening process.

In a similar way to in the case of the pump-nozzle unit according to the invention, it is also deemed advantageous in the context of the method according to the invention if it is provided that the laser-hardening process be carried out with the aid of a diode laser.

In a particularly preferred embodiment of the method according to the invention, it is provided that the material which has already been hardened by an air-hardening process is “Ovako 677”.

It is likewise deemed advantageous in the context of the method according to the invention for the bearing regions with a higher hardness and the regions which adjoin these bearing regions to be formed integrally.

In general, it is preferable for the method according to the invention for the bearing regions with a higher hardness to reach a hardness in the range from 760 HV to 850 HV, preferably in the range from 760 HV to 780 HV.

Furthermore, it is deemed advantageous for the regions which adjoin the bearing regions with a higher hardness to have a hardness in the range from 600 HV to 750 HV, preferably in the range from 650 HV to 720 HV.

An advantageous refinement of the method according to the invention provides for the bearing regions with a higher hardness to be at least partially reground.

Furthermore, the method according to the invention can provide for the bearing regions with a higher hardness to be formed with a depth of approximately 0.2 mm.

The method according to the invention can achieve particularly good results if it is provided that the hardness of the bearing regions with a higher hardness be set by a diode laser-hardening process, the diode laser being operated as a function of an output signal from at least one photodiode which records emitted radiation. The emitted radiation can be used, for example, to determine the current surface temperature, so that this temperature can be used as a feedback variable, making it possible for the actuator for the laser diodes to be actuated in such a manner that cooling with closed-loop control and/or cooling by switching off the laser is achieved.

In this context, it may in particular be provided that the emitted radiation be thermal radiation.

Furthermore, it is considered particularly advantageous to use embodiments of the method according to the invention in which it is provided that the hardness of the bearing regions with a higher hardness is set by a diode laser-hardening process, the diode laser being operated as a function of an output signal from at least one photodiode which records reflected radiation. Reflected radiation can also advantageously be used in an advantageous way for the open-loop and/or closed-loop control of the laser diodes.

It is appropriate in particular to use embodiments in which it is provided that the reflected radiation is laser radiation.

A fundamental concept of the invention consists in satisfying the demands imposed on the control valve housing by selecting a material with a lower basic hardness rather than a starting material with a high basic hardness, with this material with a lower basic hardness being hardened further by means of a laser beam in particular in the bearing regions which come into contact with the mechanical step-up converter.

### BRIEF DESCRIPTION OF THE DRAWINGS

The invention will now be explained by way of example with reference to the appended drawings and on the basis of preferred embodiments. In the drawings:

FIG. 1 shows a schematic embodiment of a pump-nozzle unit according to the invention in which the method according to the invention has been used;

FIG. 2 shows a schematic partial sectional view of a first embodiment of a control valve which can be used with the pump-nozzle unit shown in FIG. 1; and

FIG. 3 shows a schematic partial sectional view of a second embodiment of a control valve which can likewise be used with the pump-nozzle unit shown in FIG. 1.

### DETAILED DESCRIPTION OF THE PREFERRED EMBODIMENTS

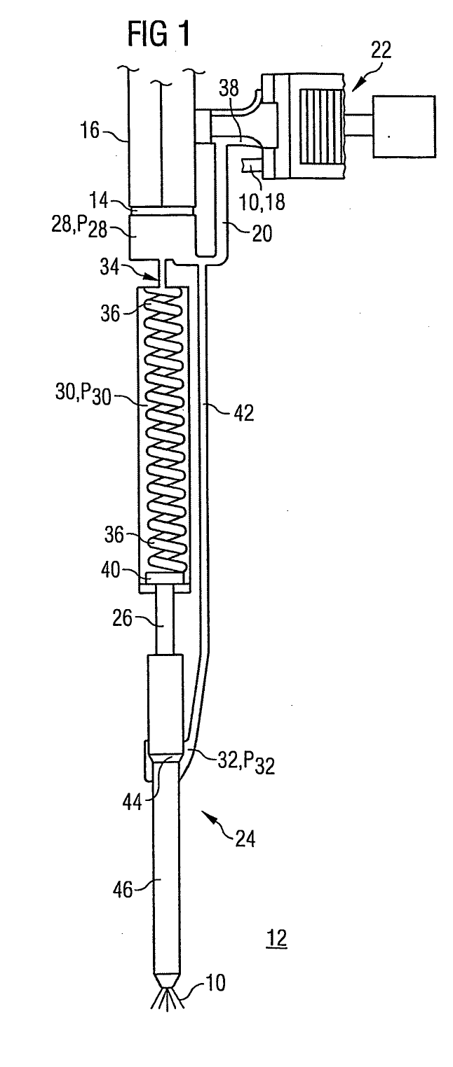

FIG. 1 schematically depicts a pump-nozzle unit. The pump-nozzle unit illustrated for feeding fuel 10 into a combustion chamber 12 of a internal combustion engine includes a fuel pump 14-22. A fuel pump piston 14 can move in a reciprocating manner in a fuel pump cylinder 16. The fuel pump piston 14 is driven directly or indirectly by means of a camshaft (not shown) of the internal combustion engine. The compression space of the fuel pump cylinder 16 forms a first pressure space 28. The first pressure space 28 is connected to a piezo control valve 22 via a fuel line 20. The piezo control valve 22 is used to either close the fuel line 20 or connect it to a low-pressure fuel region 18 from which fuel 10 can be sucked in. In the open at-rest position of the piezo control valve 22, in the event of the fuel pump piston 14 moving upward, as seen in FIG. 1, fuel 10 is sucked out of the low-pressure fuel region 18 into the first pressure space 28. As long as the piezo control valve 22 is still in its open at-rest position in the event of a downwardly directed movement of the fuel pump piston 14, as seen in FIG. 1, fuel 10 which has previously been sucked into the first pressure space 28 can be forced back into the low-pressure fuel region 18. In the event of suitable actuation of the piezo control valve 22, the latter closes the fuel line 20. As a result, the fuel 10 which has been sucked into the first pressure space 28 is compressed during a downwardly directed movement of the fuel pump piston 14, thereby generating a first pressure p₂₈ in the first pressure space 28. Furthermore, the pump-nozzle unit illustrated comprises a fuel injection nozzle, which is denoted overall by 24 and has a nozzle needle 46 which can move in a reciprocating manner between a closed position and an open position. Based on the illustration shown in FIG. 1, a pressure pin 26 can exert in particular a downwardly directed force on the nozzle needle 46. A setting disk 40, which is guided in a second pressure space 30, is provided at the upper end of the pressure pin 26, fuel 10 which is under a second pressure p30 in the second pressure space 30 exerting a downwardly directed closure force, as seen in the illustration presented in FIG. 1, on the nozzle needle 46 via the pressure pin 26. The setting disk 40 is preferably only sealed off with respect to the second pressure space 30 to an extent which is such that the second pressure p₃₀ has already been eliminated again before a new injection cycle commences. A likewise downwardly directed, further closure force is exerted on the pressure pin 26 and therefore the nozzle needle 46 by a first spring 36, the first spring 36 being arranged in the second pressure space 30 and being supported by means of its rear end on the setting disk 40. A portion of the nozzle needle 46 which has a shoulder 44 is surrounded by a third pressure space 32, which is in communication with the first pressure space 28 via a connecting line 42. Depending on the throttling action of the connecting line 42 and any further throttling devices (not shown), a third pressure p₃₂ is built up in the third pressure space 32 as a function of the first pressure p₂₈ prevailing in the first pressure space 28. The fuel 10, which is under the third pressure p₃₂ in the third pressure space 32, exerts an upwardly directed opening force, as seen in the illustration presented in FIG. 1, on the nozzle needle 46. The nozzle needle 46 adopts its open position for as long as a difference between the opening force caused by the third pressure p₃₂ and the sum of the closing force generated by the second pressure p₃₀ and the closing force generated by the first spring 36 exceeds a predetermined value. Therefore, the nozzle opening pressure can be influenced by means of the second pressure p₃₀ in the second pressure space 30. To limit the second pressure p₃₀ in the second pressure space 32 to suitable levels and to keep it at these levels, it is possible, for example, to provide a pressure-limiting and -holding valve 34 between the first pressure space 28 and the second pressure space 30.

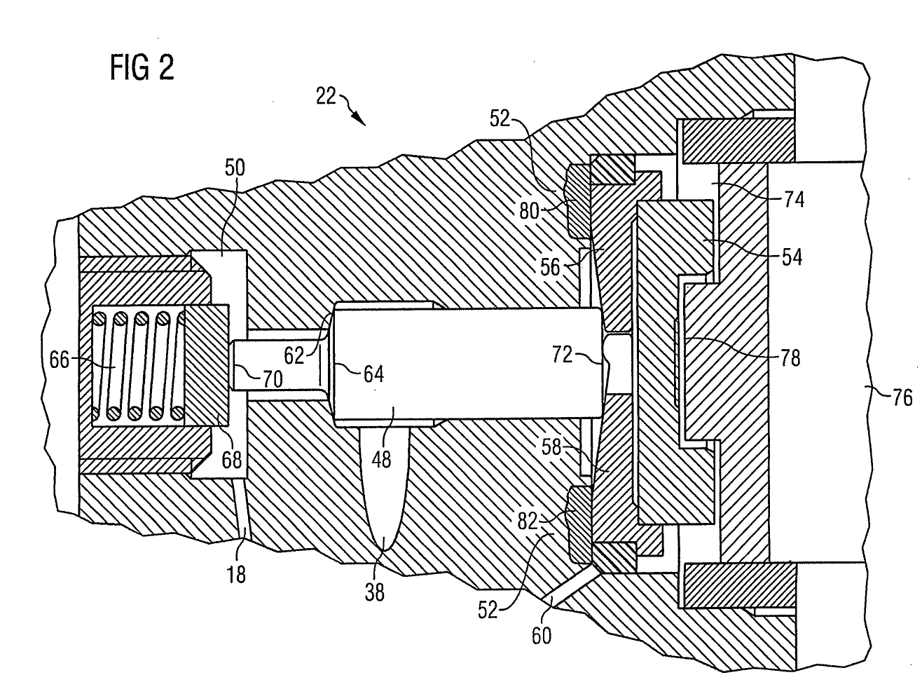

FIG. 2 shows a schematic partial sectional view of a first embodiment of a control valve which can be used with the pump-nozzle unit shown in FIG. 1. The control valve illustrated in FIG. 2 may be what is known as an I valve, i.e. a valve which closes in the direction of flow from the high-pressure region to the low-pressure region of the control valve. The piezo control valve 22 illustrated has a valve needle 48 which, in order to close the piezo control valve 22, can be moved into the first limit position illustrated, and, to completely open the piezo control valve 22, can be moved into a second limit position, which is shifted to the right based on the illustration. When the valve needle 48 is in its first limit position illustrated, a valve plate 64 provided at the valve needle 48 interacts with a housing-side valve seat 62. As a result, the low-pressure fuel region 18 is closed off with respect to a high-pressure chamber 38, which is in communication with the fuel line 20 illustrated in FIG. 1. The piezo control valve 22 has a piezo actuator or a piezo element 76. In the event of suitable actuation of the piezo element 76, the latter, via an end face 78, exerts a force on a thrust piece 54. The thrust piece 54 for its part transmits the force generated by the piezo element 76 to a first lever 56 and a second lever 58, the first lever 56 and the second lever 58 being provided for the purpose of stepping up the force and increasing the valve needle travel. The first lever 56 and the second lever 58 bear against a second axial end face 72 of the valve needle 48 in order to transmit the stepped-up force generated by the piezo element 76 to the valve needle 48. The stepped-up force which is generated by the suitably actuated piezo element 76 and acts on the valve needle 48 is greater than an opposite force which is generated by a second spring 66 and is exerted on a first axial end face 70 of the valve needle 48 via a spring thrust piece 68. The low-pressure fuel region 18 is in communication with an output control space 50, which for its part is also in communication, via a compensation bore 52, with an actuator space 74 located in front of the piezo element 76. This actuator space 74 is in communication with a return 60, via which fuel can flow back out of the actuator space 74. The first lever 56 and the second lever 54, which form the mechanical step-up converter, come into contact with regions 80, 82 of the control valve housing which have been hardened further with the aid of a diode laser, in such a manner that they have a hardness in the range from 760 HV to 780 HV. The regions 52 of the control valve housing which adjoin the bearing regions 80, 82 with a higher hardness are formed integrally with the bearing regions 80, 82 (the different hatching serves only to provide a clear representation of the regions which have been hardened further). The regions 52 which are adjacent to the bearing regions 80, 82 have a hardness, set by an air-hardening process, of from 650 HV to 720 HV. The steel “Ovako 677” supplied by Ovako is particularly preferred for material for the control valve housing. The depth of the bearing regions 80, 82 is approximately 0.2 mm, with the surfaces of the bearing regions 80, 82 which come into contact with the levers 56, 58 being reground by the removal of approximately 50 μm of material.

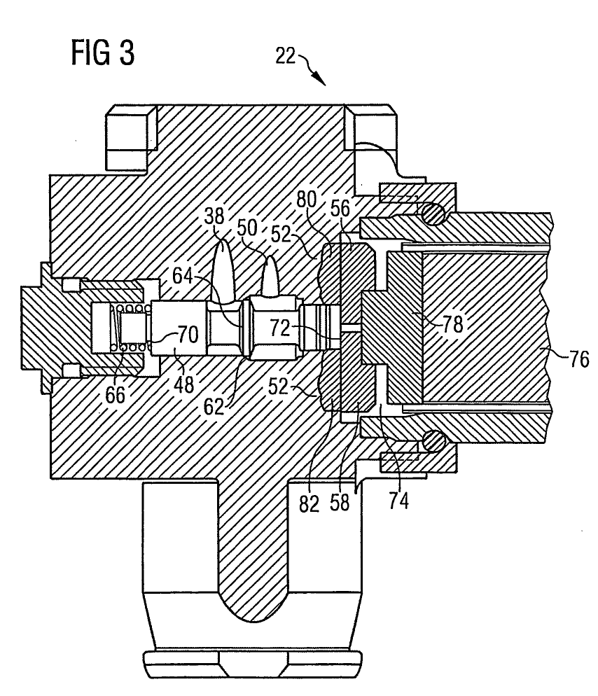

FIG. 3 shows a schematic partial sectional view of a second embodiment of a control valve, which can likewise be used with the pump-nozzle unit shown in FIG. 1. The control valve illustrated in FIG. 3 is what is known as an A-valve, i.e. a valve which closes in the opposite direction to the direction of flow from the high-pressure region to the low-pressure region. A-valves of this type often offer greater reliability with respect to undesirable jamming of the valve needle. The piezo control valve 22 illustrated has a valve needle 48 which can be moved into the first limit position illustrated in order to close the piezo control valve 22 and can be moved into a second limit position, which is shifted to the right as seen in the illustration, in order to completely open the piezo control valve 22. When the valve needle 48 is in its first limit position illustrated, a valve plate 64 provided at the valve needle 48 interacts with a valve seat 62 on the housing side. As a result, the pilot and closure space 50, which is in communication with the low-pressure fuel region, is closed off with respect to a high-pressure chamber 38 which is in communication with the fuel line 20 illustrated in FIG. 1. The piezo control valve 22 has a piezo actuator or a piezo element 76. In the event of suitable actuation of the piezo actuator 76, the end face 78 of the latter exerts a force on a first lever 56 and a second lever 58, the first lever 56 and the second lever 58 forming the mechanical step-up converter. The first lever 56 and the second lever 58 bear against a second axial end face 72 of the valve needle 48, in order to transmit the stepped-up force generated by the piezo element 76 to the valve needle 48. The stepped-up force which is generated by the suitably actuated piezo actuator 76 and acts on the valve needle 48 is greater than an opposite force which is generated by a second spring 66 and is exerted on a first axial end face 70 of the valve needle 48. In the embodiment of the control valve 22 illustrated in FIG. 3, the bearing regions 80, 82 which come into the contact with the mechanical step-up converter formed by the first lever 56 and the second lever 58 are hardened further with the aid of a laser beam. Otherwise, reference is made to the description given in connection with FIG. 2.

The invention can be summarized as follows: The invention relates to a pump-nozzle unit for feeding fuel into a combustion chamber of an internal combustion engine, having a controllable fuel pump, which comprises a control valve with a valve needle which is deflected by a piezo actuator, the comparatively small travel of the piezo actuator being increased by a mechanical step-up converter to the extent required for deflection of the valve needle. In order not to endanger the ability of the control valve housing to withstand pressure yet nevertheless to provide relatively wear-resistant bearing regions 80, 82 which come into contact with the mechanical step-up converter 56, 58, it is provided that the control valve housing is formed from a material with a relatively low basic hardness, for example from Ovako 677, and that the bearing regions 80, 82 of the control valve 22 are hardened further by laser means.

The features of the invention which are disclosed in the present description, in the drawings and in the claims may be pertinent to the realization of the invention both individually and in any desired combination.

1. A pump-nozzle unit for feeding fuel into a combustion chamber of an internal combustion engine, comprising a controllable fuel pump, which comprises a control valve with a valve needle which is deflected by a piezo actuator, the comparatively small travel of the piezo actuator being increased by a mechanical step-up converter to the extent required for deflection of the valve needle, wherein bearing regions of the control valve which come into contact with the step-up converter at least in part have a higher hardness than regions which adjoin these bearing regions.

2. The pump-nozzle unit as claimed in claim 1, wherein the hardness of the regions which adjoin the bearing regions with a higher hardness is set by an air-hardening process.

3. The pump-nozzle unit as claimed in claim 1, wherein the hardness of the bearing regions with a higher hardness is set by a laser-hardening process.

4. The pump-nozzle unit as claimed in claim 3, wherein the laser-hardening process has been applied to material that has already been hardened by an air-hardening process.

5. The pump-nozzle unit as claimed in claim 3, wherein the laser-hardening process has been carried out with the aid of a diode laser.

6. The pump-nozzle unit as claimed in claim 4, wherein the material which has already been hardened by an air-hardening process is “Ovako 677”.

7. The pump-nozzle unit as claimed in claim 1, wherein the bearing regions with a higher hardness and the regions which adjoin these bearing regions are formed integrally.

8. The pump-nozzle unit as claimed in claim 1, wherein the bearing regions with a higher hardness have a hardness in the range from 760 HV to 850 HV.

9. The pump-nozzle unit as claimed in claim 1, wherein the regions which adjoin the bearing regions with a higher hardness have a hardness in the range from 600 HV to 750 HV.

10. The pump-nozzle unit as claimed in claim 1, wherein the bearing regions with a higher hardness are at least partially reground.

11. The pump-nozzle unit as claimed in claim 1, wherein the bearing regions with a higher hardness have a depth of approximately 0.2 mm.

12. A method for setting the hardness of at least some bearing regions of a control valve, which come into contact with a mechanical step-up converter, for a pump-nozzle unit for feeding fuel into a combustion chamber of an internal combustion engine, the method comprising the steps of:
providing the mechanical step-up converter for the purpose of increasing a relatively small travel caused by a piezo actuator to an extent required for deflection of a valve needle of the control valve,
hardening the bearing regions, which come into contact with the step-up converter, of the control valve at least partially in such a manner that their hardness is higher than the hardness of regions which adjoin these bearing regions.

13. The method as claimed in claim 12, wherein the hardness of the regions which adjoin the bearing regions with a higher hardness has been set by an air-hardening process.

14. The method as claimed in claim 12, wherein the hardness of the bearing regions with a higher hardness is set by a laser-hardening process.

15. The method as claimed in claim 14, wherein the laser-hardening process is applied to material that has already been hardened by an air-hardening process.

16. The method as claimed in claim 14, wherein the laser-hardening process is carried out with the aid of a diode laser.

17. The method as claimed in claim 15, wherein the material that has already been hardened by an air-hardening process is “Ovako 677”.

18. The method as claimed in claim 12, wherein the bearing regions with a higher hardness and the regions which adjoin these bearing regions are formed integrally.

19. The method as claimed in claim 12, wherein the bearing regions with a higher hardness reach a hardness in the range from 760 HV to 850 HV.

20. The method as claimed in claim 12, wherein the regions which adjoin the bearing regions with a higher hardness have a hardness in the range from 600 HV to 750 HV.

21. The method as claimed in claim 12, wherein the bearing regions with a higher hardness are at least partially reground.

22. The method as claimed in claim 12, wherein the bearing regions with a higher hardness are formed with a depth of approximately 0.2 mm.

23. The method as claimed in claim 12, wherein the hardness of the bearing regions with a higher hardness is set by a diode laser-hardening process, the diode laser being operated as a function of an output signal from at least one photodiode which records emitted radiation.

24. The method as claimed in claim 23, wherein the emitted radiation is thermal radiation.

25. The method as claimed in claim 12, wherein the hardness of the bearing regions with a higher hardness is set by a diode laser-hardening process, the diode laser being operated as a function of an output signal from at least one photodiode which records reflected radiation.

26. The method as claimed in claim 25, wherein the reflected radiation is laser radiation.
